(19) United States
(12) Patent Application Publication
(10) Pub. No.: US 2003/0044496 A1
(43) Pub. Date: Mar. 6, 2003

(54) Apparatus and method for recovering injection solution

(76) Inventors: Larry C. Gundlach, Madison, WI (US); James A. Rattmann, Marshall, WI (US)

Correspondence Address: MEDLEN & CARROLL, LLP, 101 HOWARD STREET, SUITE 350, SAN FRANCISCO, CA, 94105, US

(21) Appl. No.: 09/938,193

(22) Filed: Aug. 23, 2001

(51) Int. Cl. A23L 1/31

(52) U.S. Cl. 426/281

(57) ABSTRACT

The present invention relates to the field of meat processing, and in particular the recovery and reuse of solutions injected into meat products. Methods are provided for injecting meat products with an injection solution, compressing the meat product to recover excess injection solution, and reusing the recovered excess injection solution to inject additional meat products. The present invention also provides systems and apparatuses for carrying out these methods. The present invention also provides meat products produced by these methods.

### FIELD OF THE INVENTION

The present invention relates to the field of meat processing, and in particular to the recovery and reuse of solutions injected into meat products.

### BACKGROUND OF THE INVENTION

During the manufacture of bacon, the pork belly is injected with a brine solution commonly containing water, salt, sugar, sodium nitrite, sodium ascorbate, and liquid smoke. Injection levels are adjusted to the amount after draining that will subsequently be evaporated during smokehouse processing and chilling so that the bacon conforms to the USDA requirement of averaging 100% or less of the weight of the initial non-injected belly weight. The pork belly is then hung on a rack and taken to the smokehouse. When the belly is hung, excess brine solution drains from the belly. The cost of the brine solution can exceed one dollar per pound. Therefore, the loss of excess injected brine solution adds a considerable cost to the production of bacon. Brine losses during a day's operation can exceed 30% of total use.

Currently, many bacon manufacturers attempt to recover the excess brine solution that drains from the bellies as they hang on the racks. However, once the rack is full, the rack is removed to the smokehouse and significant brine loss can still occur because the bellies continue to drain for 2-3 hours. Accordingly, what are needed in the art are improved processes and systems for recovering and reusing excess injected brine solution.

### SUMMARY OF THE INVENTION

The present invention relates to the field of meat processing, and in particular to the recovery and reuse of solutions injected into meat products. Accordingly, in some embodiments, the present invention provides an apparatus comprising an injector configured to inject a solution into a meat product and a compressor aligned with the injector, so that when the meat product injected with the solution is passed through the compressor the excess solution is at least partially recovered. In other embodiments, the apparatus further comprises at least one conveying belt between the injector and the compressor, so that the meat product can be conveyed from the injector to the compressor. In still other embodiments, the apparatus further comprises a reservoir for collecting the solution recovered from the meat product. The present invention is not limited to any particular type of injector. Indeed, a variety of injectors are contemplated including, but not limited to, common manifold needle injectors (manifold injectors), array syringe injectors, and pressure injectors. The present invention is not limited to any particular type of compressor. Indeed, the use of a variety of compressors is contemplated, including but not limited to: a compressor comprising at least one roller bar so that when the meat product is caused to pass the at least one roller bar the product is compressed; a compressor comprising at least one planar surface operably linked to a piston, wherein operation of the piston causes the planar surface to compress the meat product; a compressor comprising a plurality of squeeze rollers; a compressor comprising a pair of compression rollers; and a compressor comprising a vacuum unit. The present invention is not limited to any particular injection solution. Indeed, a variety of injection solutions are contemplated, including brine injection solutions. The present invention is not limited to any particular meat product. Indeed, a variety of meat products are contemplated, including, but not limited to pork bellies.

In other embodiments, the present invention provide systems for recovering injection solution from injected meat products, wherein the systems comprise an injector configured to inject meat products with an injection solution; and a compressor configured to compress the injected meat products, wherein the compressing causes at least partial expulsion of the injection solution from the meat product. In further embodiments, the systems of the present invention further comprise a designated pathway configured to convey the meat product from the injector to the compressor. In particularly preferred embodiments, the compressor is downstream of the injector on the designated pathway. In still other embodiments, the systems of the present invention further comprise a reservoir for collecting the injection solution. In some preferred embodiments, the reservoir is in fluid communication with the injector so that the injection solution can be recycled. As described in more detail above, the systems of the present invention are not limited to any particular injector, compressor, injection solution, or meat product.

In still other embodiments, the present invention provides methods for recovering injection solution from a meat product comprising providing a meat product and an injection solution; injecting the meat product with the injection solution to provide an injected meat product; mechanically treating the injected meat product under conditions such that the injection solution is at least partially expelled from the meat product; and hanging the injected meat product. In some preferred embodiments, the methods further comprise the steps of recovering the at least partially expelled injection solution to provide recovered injection solution and repeating the injecting and treating steps with the recovered injection solution. As described in more detail above, the methods of the present invention are not limited to any particular injector, compressor, injection solution, or meat product.

In further embodiments, the present invention provides methods comprising providing a meat product and an injection solution; injecting the meat product with the injection solution to provide an injected meat product; mechanically treating the meat product to recover at least a portion of the injection solution from the injected meat product to provide recovered injection solution; and reusing the recovered injection solution to inject additional meat products. As described in more detail above, the methods of the present invention are not limited to any particular injector, compressor, injection solution, or meat product.

In still further embodiments, the present invention provides methods comprising providing a meat product; an injection solution; and a system comprising an injection solution return unit in fluid communication with an injector; injecting the meat product via the injector with the injection solution to provide an injected meat product; mechanically treating the meat product to recover at least a portion of the injection solution from the injected meat product via the injection solution return unit to provide recovered injection solution; and reusing the recovered injection solution.

In some embodiments, the present invention provides methods for increasing the liquid holding capacity of meat products comprising providing a meat product and an injection solution; injecting the meat product with the injection solution to provide an injected meat product; mechanically treating the injected meat product under conditions such that the liquid holding capacity of the meat product is increased as compared to non-compressed injected meat products. In still other embodiments, the present invention provides methods for decreasing the amount of injection solution required for injecting meat products comprising providing a meat product and an injection solution; injecting the meat product with the injection solution to provide an injected meat product; compressing the injected meat product under conditions such that the injection solution is retained as compared to non-compressed injected meat products. As described in more detail above, the methods of the present invention are not limited to any particular injector, compressor, injection solution, or meat product.

In further embodiments, the present invention provides a meat product, and in particularly preferred embodiments, a pork belly, produced by any of the preceding methods.

### DESCRIPTION OF THE FIGURES

FIG. 1 provides a flow chart summarizing the systems of the present invention.

FIG. 2 is a side elevation view of a roller bar compression apparatus.

FIG. 3 is a side elevation view of a traveling platen compression apparatus.

FIG. 4 is a side elevation view of a squeeze roller apparatus.

FIG. 5 is a side elevation view of a compression roller bar apparatus.

FIG. 6 is a side elevation view of a vacuum apparatus.

### DETAILED DESCRIPTION OF THE INVENTION

The present invention relates to the field of meat processing, and in particular to the recovery and reuse of solutions injected into meat products. In particularly preferred embodiments of the present invention, methods and systems are provided for injecting a brine solution into a pork belly, mechanically treating the pork belly to recover excess injected brine solution prior to hanging, and reusing the recovered excess brine solution. It is contemplated that the ability to recover and reuse excess injected brine solution will result in significant cost savings for bacon production. The apparatus and methods of the present invention are also environmentally friendly because the amount of wastewater produced during bacon processing is substantially reduced. Additionally, less water may be required to inject into the belly; in some embodiments that may increase water holding capacity, and still achieve the legal limit of shrinkage defined by the USDA.

The present invention is not limited to any particular bacon processing apparatus. Indeed, a variety of configurations of injectors and compression devices are encompassed by the present invention. Non-limiting examples of the apparatuses of the present invention and methods of their use are described in detail below.

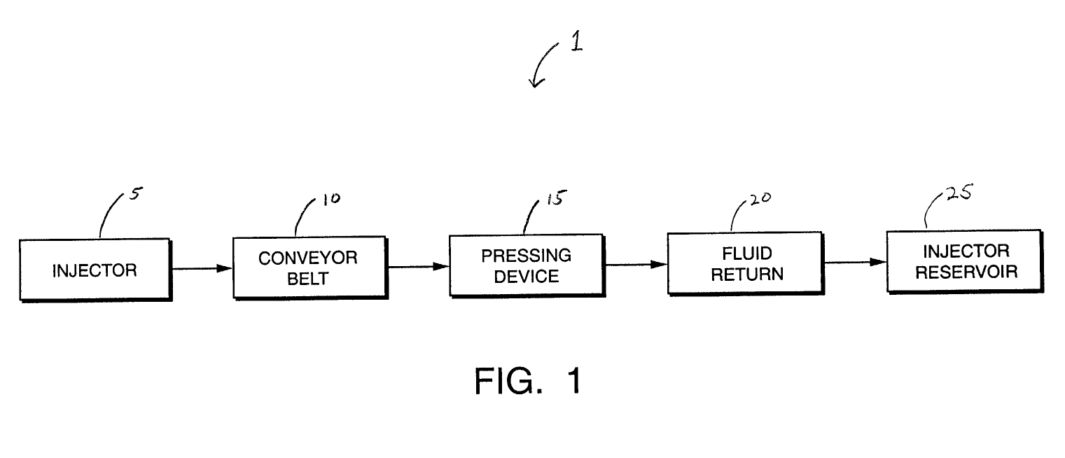

FIG. 1 provides a flow chart summarizing a system of the present invention. Referring to FIG. 1, a system 1 of the present invention comprises an injector 5, a conveyor belt 10, a pressing device or compressor 15, a fluid return 20, and an injector reservoir 25. A variety of injectors 5 find use in the present invention. In some preferred embodiments, the injector 5 is a common manifold injector available from Townsend Engineering, Des Moines, Iowa, USA. Other suitable injectors are described in U.S. Pat. Nos. 3,661,072 and 5,200,223, which are incorporated herein by reference. In general, suitable injection units comprise an array of needles in fluid communication with an injector reservoir via tubing (not shown). Injection solution is pumped from the injector reservoir through the tubing to the needle from which the brine solution is injected into the meat product (e.g., pork belly). In other embodiments of the present invention, the injection solution is injected into the belly in a fluid stream via an injection device comprising a plurality of high pressure nozzles (i.e., a pressure injector) through which the injection solution is pumped at high pressure.

Still referring to FIG. 1, the system of the present invention further comprises a conveyor belt 10 for delivering an injected meat product from the injector 5 to the compressor 15. A variety of conveyor belt 10 arrangements find use in the present invention. For example, the conveyor 10 may be in multiple segments or a single continuous belt between the injector 5 and compressor 15. Furthermore, the conveyor belt 10 may be solid, or alternatively, have openings therein to provide for efficient drainage of the brine solution to the fluid return.

In some embodiments, the system of the present invention (see FIG. 1) also comprises a compressor 15 for mechanically treating (e.g., compressing) a meat product so that excess injected injection solution can be expelled from the meat product. The present invention is not limited to a single type of compressor 15. Indeed, a variety of compressors 15 are contemplated, including but not limited to roller bars, squeeze rollers, planar surfaces, and vacuums, each of which is described in more detail below. In general, the meat product is conveyed from the injector 5 to the compressor 15 via the conveyor belt 10 and the meat product is compressed so that the injection solution is expelled.

Referring again to FIG. 1, the system 1 of the present invention further comprises a fluid return unit 20 and injector reservoir 25. The fluid return unit collects the expelled injection solution from the compressor 15 and causes delivery of the recovered injection solution to the injector reservoir 25 where the recovered injection solution is reused for injecting additional meat product. Accordingly, in preferred embodiments, the fluid return unit 20 and injector reservoir 25 are in fluid communication with one another via a pipe or tube. In some preferred embodiments, the fluid return unit 20, injector reservoir 25, or tubing or pipe is fitted with a filter unit to filter the injection solution before it is delivered to the injector.

As can be seen from the foregoing disclosure, the systems of the present invention are not limited to any particular configuration. Nevertheless, a number of preferred apparatuses corresponding to the systems of the present invention are set forth below in detail.

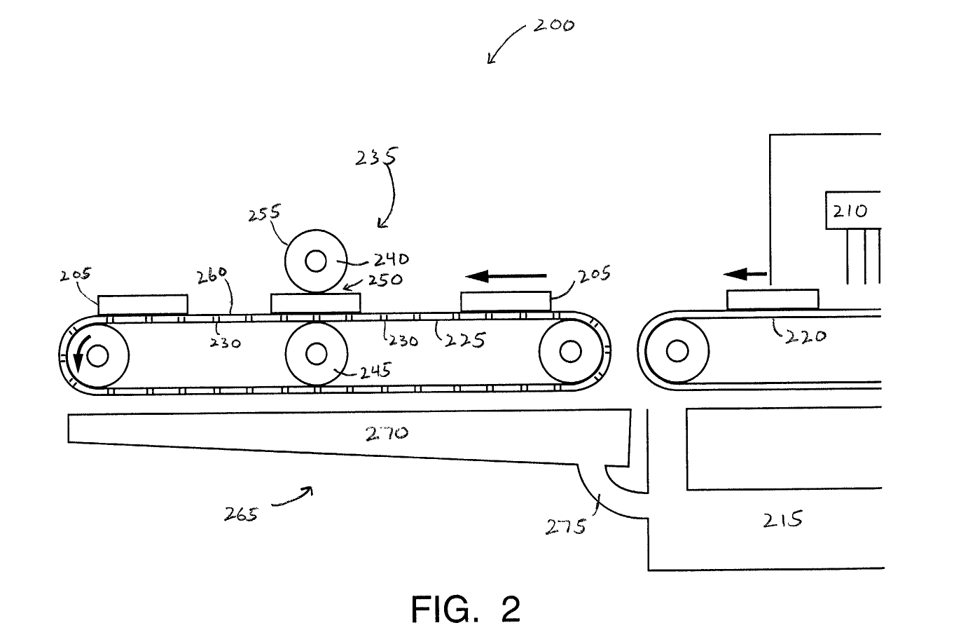

Referring to FIG. 2, a roller bar apparatus 200 for injecting and recovering injection solution from a meat product 205 comprises an injector 210 for injecting a meat product 205, preferably a pork belly. The injector 210 (e.g., common manifold needle injector) is in fluid communication with an injector reservoir 215, where injection solution is stored. After injection of injection solution into the meat product 205, the meat product 205 is conveyed via a first conveyor belt 220 to a second conveyor belt 225. The second conveyor belt 225 preferably has therein a plurality of openings 230 that allow drainage of expelled injection solution. The second conveyor belt 225 delivers the injected meat product 205 to a compressor 235. It will be recognized that in some embodiments a single conveyor belt may be substituted for the first and second conveyor belts 220 and 225.

Still referring to FIG. 2, a compressor 235 preferably comprises an upper roller bar 240 and a lower roller bar 245. The upper and lower roller bars 240 and 245 are configured so that the meat product 205 on the second conveyor belt 225 passes through the roller bar opening 250. As the meat product 205 passes through the roller bar opening 250, the meat product 205 contacts the upper roller bar surface 255 and second conveyor belt outside surface 260. The surface of the upper and lower bars 240 and 245 roller bars may be smooth or textured (e.g., have grooves therein). The meat product 205 is compressed between the upper roller bar surface 255 and second conveyor belt outside surface 260 so that the excess injection solution is expelled. It will be understood that the size of the roller bar opening 250 can be varied to vary the pressure exerted on the meat product 205. Furthermore, a sensing unit (not shown) may be attached to the roller bars so that the width of the roller bar opening 250 is varied with individual meat products.

Referring again to FIG. 2, as the meat product 205 is pressed between the upper roller bar surface 255 and second conveyor belt outside surface 260 injection solution is expelled and drains through the openings 230 in the second conveyor belt 225 so that it is delivered to the injection solution return unit 265. The injection solution return unit 265 comprises a catch pan 270 in fluid communication with the injector reservoir 215. In preferred embodiments, a hose 275 fluidly connects the catch pan 270 and injector reservoir 215. Accordingly, excess injection solution that is expelled from the meat product 205 due to the pressing action of the upper roller bar and second conveyor belt outside surfaces 255 and 260 collects in the catch pan 270 and is then delivered to the injector reservoir 215 where the recovered excess injection solution is reused to inject additional meat products 205. In some embodiments, a filter (not shown) is arranged in the catch pan 270, hose 275, or injector 210 so that the recovered excess injection solution can be filtered prior to entering the injector 210.

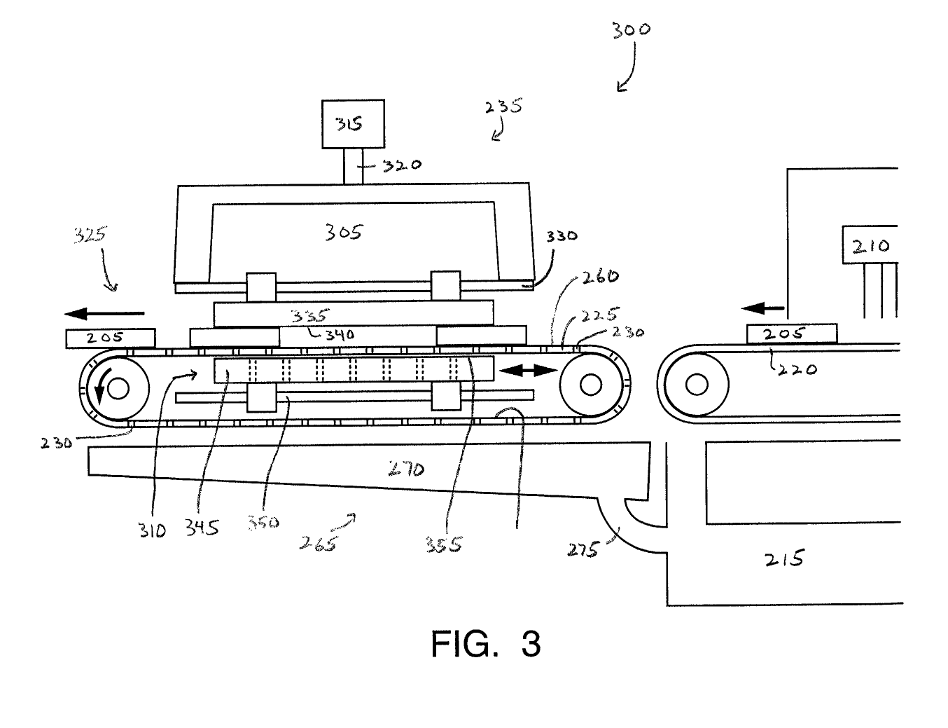

Referring to FIG. 3, a traveling platen apparatus 300 for injecting and recovering injection solution from a meat product 205 comprises an injector 210 for injecting a meat product 205, preferably a pork belly. The injector 210 (e.g., common manifold needle injector) is in fluid communication with the injector reservoir 215, where injection solution is stored. After injection of injection solution into the meat product 205, the meat product 205 is conveyed via a first conveyor belt 220 to a second conveyor belt 225. The second conveyor belt 225 preferably has therein a plurality of openings 230 that allow drainage of expelled injection solution. The second conveyor belt 225 delivers the injected meat product to a compressor 235. It will be recognized that in some embodiments a single conveyor belt may be substituted for the first and second conveyor belts 220 and 225.

Still referring to FIG. 3, a compressor 235 preferably comprises an upper traveling platen unit 305 and a lower traveling platen unit 310. The upper traveling platen unit 305 is configured for translational movement to move with the meat product 205 as the meat product 205 moves along the second conveyor belt 225. Accordingly, a continuous stream of meat products 205 may be moved through the apparatus 300. The upper traveling platen 305 comprises a pneumatic cylinder 315 and piston arrangement 320 so that the upper traveling platen 305 may be lifted and returned to the injector 210 side of the second conveyor belt 225 after traveling to the exit end 325 of the second conveyor belt 225. The upper traveling platen 305 further comprises a platen rail 330 to which an upper platen 335 is fixed. The upper platen 335 preferably has an upper planar surface 340 for contacting and pressing the injected meat product 205. It is contemplated that the upper planar surface 340 may be completely flat or that it may have a textured surface.

The lower traveling platen unit 310 is configured to move in concert with the upper traveling platen unit 305 so that constant pressure can be maintained on the meat product 205 moving along the second conveyor belt 225. The lower traveling platen unit 310 is also fixed to a pneumatic system (not shown) for translational movement. The lower traveling platen unit 310 comprises a lower platen 345 fixed to a lower platen rail 350. The lower platen 345 preferably has a lower planar surface 355 for contacting the inside surface 360 of the second conveyor belt 225. Thus, the meat product 205 is pressed between the second conveyor belt outside surface 260 and upper platen planar surface 340. It is contemplated that the lower planar surface 355 may be completely flat or that it may have a textured surface. As the upper and lower platen traveling units 305 and 310 extend in concert and press the meat product 205, the meat product 205 is moved along the second conveyor belt 225. Thus, the upper and lower platen 305 and 310 travel distance and belt speed determine the total press time.

Referring again to FIG. 3, as the meat product 205 is pressed between the second conveyor belt outside surface 260 and upper platen planar surface 340, injection solution is expelled and drains through the openings 230 in the second conveyor belt 225 so that it is delivered to the injection solution return unit 265. The injection solution return unit 265 comprises a catch pan 270 in fluid communication with the injector reservoir 215. In preferred embodiments, a hose 275 fluidly connects the catch pan 270 and injector reservoir 215. Accordingly, excess injection solution that is expelled from the meat product 205 due to the pressing action of the surfaces 260 and 340 collects in the catch pan 270 and is then delivered to the injector reservoir 215 where the recovered excess injection solution is reused to inject additional meat products 205. In some embodiments, a filter (not shown) is arranged in the catch pan 270, hose 275, or injector 210 so that the recovered excess injection solution can be filtered prior to entering the injector 210.

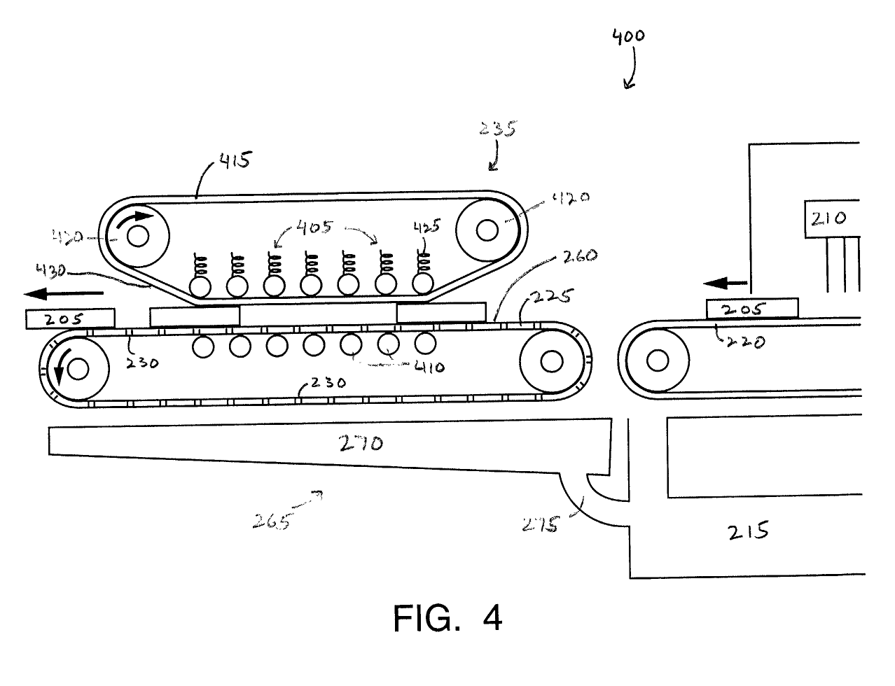

Referring to FIG. 4, a squeeze roller apparatus 400 for injecting and recovering injection solution from a meat product 205 comprises an injector 210 for injecting a meat product 205, preferably a pork belly. The injector 210 (e.g., common manifold needle injector) is in fluid communication with the injector reservoir 215, where injection solution is stored. After injection of injection solution into the meat product 205, the meat product 205 is conveyed via a first conveyor belt 220 to a second conveyor belt 225. The second conveyor belt 225 preferably has therein a plurality of openings 230 that allow drainage of expelled injection solution. The second conveyor belt 225 delivers the injected meat product 205 to a compressor 325. It will be recognized that in some embodiments a single conveyor belt may be substituted for the first and second conveyor belts 220 and 225.

Still referring to FIG. 4, a compressor 235 preferably comprises a plurality of squeeze rollers 405 and support rollers 410. The squeeze rollers 405 contact a moving tread 415 that travels around a pair of bearing sprockets 420. The squeeze rollers 405 are attached to springs 425 that exert downward pressure on the squeeze rollers 405 and thus the moving tread 415. In some embodiments, the squeeze rollers 405 are aligned directly over the support rollers 410. In other embodiments (not shown), the squeeze rollers 405 and support rollers 410 are not directly aligned. As the injected meat product 205 moves through the compressor 235, the downward pressure exerted by the squeeze roller springs 425 causes the meat product 205 to be pressed between the moving tread surface 430 and second conveyor belt surface 260. This pressing action causes excess injection solution to be expelled from the meat product 205.

Referring again to FIG. 4, as the meat product 205 is pressed between the moving tread surface 430 and second conveyor belt surface 260 injection solution is expelled and drains through the openings 230 in the second conveyor belt 225 so that it is delivered to the injection solution return unit. The injection solution return unit 265 comprises a catch pan 270 in fluid communication with the injector reservoir 215. In preferred embodiments, a hose 275 fluidly connects the catch pan 270 and injector reservoir 215. Accordingly, excess injection solution that is expelled from the meat product 205 due to the pressing action of the upper and lower surfaces 260 and 430 collects in the catch pan 270 and is then delivered to the injector reservoir 215 where the recovered excess injection solution is reused to inject additional meat products 205. In some embodiments, a filter (not shown) is arranged in the catch pan 270, hose 275, or injector 210 so that the recovered excess injection solution can be filtered prior to entering the injector 210.

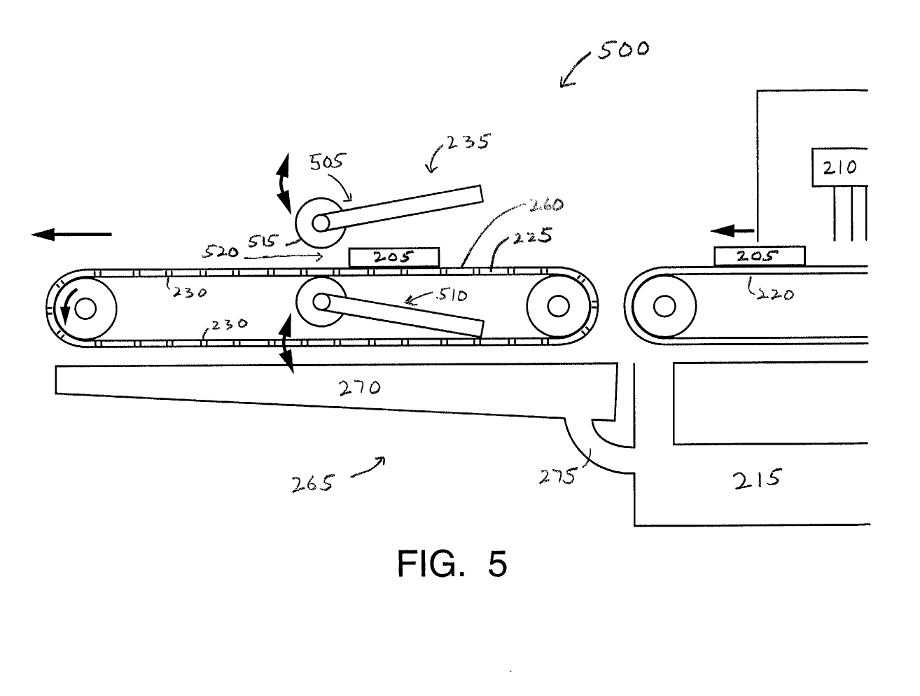

Referring to FIG. 5, a powered compression roller apparatus 500 for injecting and recovering injection solution from a meat product 205 comprises an injector 210 for injecting a meat product 205, preferably a pork belly. The injector 210 (e.g., common manifold needle injector) is in fluid communication with the injector reservoir 215, where injection solution is stored. After injection of injection solution into the meat product 205, the meat product 205 is conveyed via a first conveyor belt 220 to a second conveyor belt 225. The second conveyor belt 225 preferably has therein a plurality of openings 230 that allow drainage of expelled injection solution. The second conveyor belt 225 delivers the injected meat product 205 to a compressor 235. It will be recognized that in some embodiments a single conveyor belt may be substituted for the first and second conveyor belts 220 and 225.

Still referring to FIG. 5, the compressor 235 preferably comprises an upper compression roller 505 and a lower compression roller 510. The upper and lower compression rollers 505 and 510 are preferably pneumatically or hydraulically powered (not shown) so they that they can be aligned to press meat products 205 traveling down the second conveyor belt 225. As the meat product travels down the conveyor belt 225, the upper compression roller 505 lowers and the lower compression roller 510 raises as the meat product 205 approaches. Thus, the meat product 205 is brought into contact with the surface 515 of the upper compression roller 505 and pressed against the outer surface 260 of the second conveyor belt 225. The surfaces of the upper and lower compression rollers 505 and 510 may be smooth or textured (e.g., have grooves therein). It will be understood that the size of the roller bar opening 520 can be varied to vary the pressure exerted on the meat product 205. Furthermore, a sensing unit (not shown) may be attached to the roller bars so that the roller bar opening is varied with individual meat products 205.

Referring again to FIG. 5, as the meat product 205 is pressed between the upper compression roller surface 515 and second conveyor belt outer surface 260 injection solution is expelled and drains through the openings 230 in the second conveyor belt 225 so that it is delivered to the injection solution return unit 265. The injection solution return unit 265 comprises a catch pan 270 in fluid communication with the injector reservoir 215. In preferred embodiments, a hose 275 fluidly connects the catch pan 270 and injector reservoir 215. Accordingly, excess injection solution that is expelled from the meat product 205 due to the pressing action of the surfaces 260 and 515 collects in the catch pan 270 and is then delivered to the injector reservoir 215 where the recovered excess injection solution is reused to inject additional meat products 205. In some embodiments, a filter (not shown) is arranged in the catch pan 270, hose 275, or injector 210 so that the recovered excess injection solution can be filtered prior to entering the injector 210.

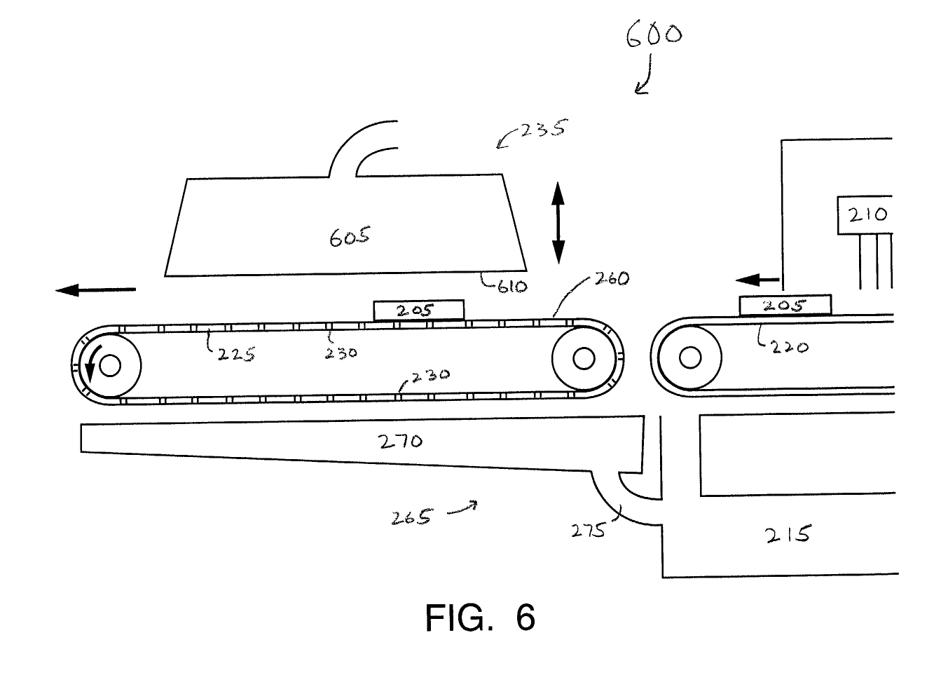

Referring to FIG. 6, a vacuum apparatus 600 for injecting and recovering injection solution from a meat product 205 comprises an injector 210 for injecting a meat product 205, preferably a pork belly. The injector 210 (e.g., common manifold needle injector) is in fluid communication with the injector reservoir 215, where injection solution is stored. After injection of injection solution into the meat product 205, the meat product 205 is conveyed via a first conveyor belt 220 to a second conveyor belt 225. The second conveyor belt 225 preferably has therein a plurality of openings 230 that allow drainage of expelled injection solution. The second conveyor belt 225 delivers the injected meat product 205 to a vacuum unit 605. It will be recognized that in some embodiments a single conveyor belt may be substituted for the first and second conveyor belts 220 and 225.

Still referring to FIG. 6, the compressor 235 preferably comprises a vacuum unit 605 in communication with a vacuum source (not shown). The vacuum unit 605 is preferably configured to lower when a meat product 205 is positioned directly below the vacuum unit 605. As the edges 610 of the vacuum unit 605 contact the second conveyor belt, a vacuum is applied. Once the maximum vacuum level is reached, the vacuum is released and the vacuum unit raises. This action causes the injected meat product 205 to expand and contract which in turn causes excess injection solution to be expelled from the meat product 205. In preferred embodiments, a sensing unit (not shown) may be attached the vacuum unit 605 to control lowering of the vacuum unit 605 when a meat product 205 is positioned below the vacuum unit 605.

Referring again to FIG. 6, as the vacuum is released, excess injection solution is expelled and drains through the openings 230 in the second conveyor belt 225 so that it is delivered to the injection solution return unit 265. The injection solution return unit 265 comprises a catch pan 270 in fluid communication with the injector reservoir 215. In preferred embodiments, a hose 275 fluidly connects the catch pan 270 and injector reservoir 215. Accordingly, excess injection solution that is expelled from the meat product 205 collects in the catch pan 270 and is then delivered to the injector reservoir 215 where the recovered excess injection solution is reused to inject additional meat products 205. In some embodiments, a filter (not shown) is arranged in the catch pan 270, hose 275, or injector 210 so that the recovered excess injection solution can be filtered prior to entering the injector 210.

It will be further understood that the present invention encompasses methods for recovering excess injection solution from injected meat products. The practice of these methods is not limited to the use the systems and apparatuses described above. Indeed, it is envisioned that a variety of alternative systems and apparatuses may be utilized to practice the inventive methods.

In some embodiments, the methods of the present invention comprise injecting a meat product with an injection solution and mechanically treating the meat product to at least partially recover excess injection solution. “At least partially recovering” refers to the fact that not all of the injected injection solution is recovered. Indeed, a portion of the injection solution is retained within the injected meat product and retention is adjusted to the amount needed to compensate for the smokehouse and chilling shrinkage to result in a finished weight that equals the initial raw belly weight. In preferred embodiments, the injected meat product is a pork belly and the mechanical treatment step is performed prior to hanging the bellies on a rack for transport to a smokehouse and smoking. In this way, the recovered injection solution is maintained at the site of injection, rather than being allowed to drain into collection in the racks. Thus, in preferred embodiments, the recovered injection solution is reused to inject fresh pork bellies in a closed loop system. In some particularly preferred embodiments, the recovered injection solution is filtered prior to delivery to the injector. As described above, the mechanical treatment step can be accomplished via the use of a variety of compression and other devices, including but not limited to, roller bar devices, traveling platen devices, spring roller devices, compression roller devices, and vacuum units.

It will be recognized that combinations of the elements of the various embodiments described above are within the scope of the of the present invention. For example, the traveling platen system or roller bar systems may be combined with the vacuum system so that the meat product is compressed following vacuum treatment. Alternatively, any of the pressing systems may be used in conjunction with another.

Additionally, the present invention provides methods of reducing the volume of brine solution needed to inject pork bellies while still providing USDA required amounts of sodium nitrite and ascorbate. The actual amount of reduction of brine solution needed depends on smokehouse and chilling procedures. In particular, less brine is needed when the time needed for smoking and/or chilling is shorter. Alternatively, the present invention provides an embodiment that improves the water holding capacity of an injected meat product such as a pork belly.

The methods of the present invention provide at least three distinct benefits. First, the excess injection solution, which often contains costly ingredients such as liquid smoke, is recycled, resulting in saved costs. Second, because the excess injection solution is reused, wastewater pollution is reduced. Third, as described in the examples, the compressed meat products of the present invention lose less brine than meat products that are not compressed after injection. The present invention is not limited to any particular mechanism of action. Indeed, an understanding of the mechanism of action is not necessary to practice the present invention. Nevertheless, it is believed that the extra retention could be caused by better dispersion of the injection solution within the muscle and fat of the injected meat product. Alternatively, the needle holes resulting from syringe-type injection could be closed, preventing further drainage. Thus, the methods of the present invention enable the use of more concentrated brine solutions, thereby reducing water use and wastewater pollution.

### EXAMPLES

The following examples serve to illustrate certain preferred embodiments and aspects of the present invention and are not to be construed as limiting the scope thereof.

### Example 1

This Example describes the recovery of brine solution by compression of injected pork bellies. Two lots of 5 bellies each were injected with a standard brine solution with an initial pick-up of ˜14%. The bellies were then either allowed to drain or compressed manually by rolling and squeezing as would be done in a roller. The amount of recovered brine solution for the two groups was then measured over time. The results are summarized as follows:

| Control (gravity drain): | |
|---|---|
| Initial pick-up %: | 13.5% |
| Pick-up after draining 1 hr: | 10.8% |
| Percent brine lost due to draining | 20.2% |
| Test (squeezing): | |
| Initial pick-up % | 14.2% |
| Pick-up after compression: | 12.1% |
| Percent injected brine lost due to squeezing: | 14.6% |
| Pick-up after squeezing and 1 hr draining: | 12.0% |
| Percent injected brine lost due to draining: | 0.8% |
| Percent brine lost due to squeezing and draining: | 15.4% |

The expected result was that the brine lost due to draining in the control group and the brine lost due to squeezing and draining in the test group would be the same. However, as the results show, the squeezed pork bellies exhibited less brine loss. These results confirm that compression following injection can be used to recover brine solution from injected pork bellies.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in food processing, meat science, and food science are intended to be within the scope of the following claims.

What is claimed is:

1. An apparatus comprising:
a) an injector configured to inject a solution into a meat product; and
b) a compressor aligned with said injector, so that when said meat product injected with said solution is passed through said compressor said solution is at least partially recovered.

2. The apparatus of claim 1, further comprising a conveyor belt between said injector and said compressor, so that said meat product can be conveyed from said injector to said compressor.

3. The apparatus of claim 1, further comprising a reservoir for collecting said solution recovered from said meat product.

4. The apparatus of claim 1, wherein said injector is selected from the group consisting of manifold injectors and pressure injectors.

5. The apparatus of claim 1, wherein said compressor comprises at least one roller bar so that when said meat product is caused to pass said at least one roller bar said meat product is compressed.

6. The apparatus of claim 1, wherein said compressor comprises at least one planar surface operably linked to a piston, wherein operation of said piston causes said planar surface to compress said meat product.

7. The apparatus of claim 1, wherein said meat product is a pork belly.

8. The apparatus of claim 1, wherein said solution is a brine solution.

9. A system for recovering injection solution from injected meat products comprising
a) an injector, wherein said injector configured to inject meat products with an injection solution; and
b) a compressor, wherein said compressor is configured to compress said meat product to cause at least partial expulsion of said injection solution from said meat product.

10. The system of claim 9, further comprising a designated pathway for conveying said meat product.

11. The system of claim 10, wherein said compressor is downstream of said injector on said designated pathway.

12. The system of claim 9, further comprising a reservoir for collecting said injection solution.

13. The system of claim 12, wherein said reservoir is in fluid communication with said injector so that said injection solution can be recycled.

14. The system of claim 9, wherein said injector is selected from the group consisting of manifold injectors and pressure injectors.

15. The system of claim 9, wherein said compressor comprises at least one roller bar so that when said meat product is caused to pass said at least one roller bar said meat product is compressed.

16. The system of claim 9, wherein said compressor comprises at least one planar surface operably linked to a piston, wherein operation of said piston causes said planar surface to compress said meat product.

17. A method for recovering injection solution from a meat product comprising
a) providing
i) a meat product; and
ii) an injection solution;
b) injecting said meat product with said injection solution to provide an injected meat product;
c) mechanically treating said injected meat product under conditions such that said injection solution is at least partially expelled from said meat product; and
d) hanging said injected meat product.

18. The method of claim 17, wherein said meat product is a pork belly.

19. The method of claim 17, wherein said injection solution is a brine solution.

20. The method of claim 17, further comprising the step of recovering said at least partially expelled injection solution to provide recovered injection solution and repeating steps b) and c) with said recovered injection solution.

21. The method of claim 17, wherein said injecting is accomplished with a manifold injector.

22. The method of claim 17, wherein said compressing is accomplished via a roller bar system.

23. The method of claim 17, wherein said compressing is accomplished via a piston-driven planar surface.

24. A method comprising
a) providing
i) a meat product; and
ii) an injection solution;
b) injecting said meat product with said injection solution to provide an injected meat product;
c) mechanically treating said meat product to recover at least a portion said injection solution from said injected meat product to provide recovered injection solution; and
d) reusing said recovered injection solution to inject additional meat products.

25. The method of claim 17, wherein said meat product is a pork belly.

26. The method of claim 17, wherein said injection solution is a brine solution.

27. A method comprising
a) providing
i) a meat product;
ii) an injection solution; and
iii) a system comprising an injection solution fluid return unit in fluid communication with an injector; and
b) injecting said meat product via said injector with said injection solution to provide an injected meat product;
c) mechanically treating said meat product to recover at least a portion of said injection solution from said injected meat product via said injector solution return unit to provide recovered injection solution; and
d) reusing said recovered injection solution.

28. A meat product produced by the method of claim 17.
